(19) United States
(12) Patent Application Publication
(10) Pub. No.: US 2008/0300999 A1
(43) Pub. Date: Dec. 4, 2008

(54) System for Aggregating Services for a Telecommunication Platform and Method of Ordering a Good or Service

(75) Inventors: Anthony Sayn, Auribeau (FR); David Gaborit, Le Tignet (FR); Jean-Philippe Carion, Mougins (FR); Julien Clausse, Opio (FR)

Correspondence Address: AKERMAN SENTERFITT, P.O. BOX 3188, WEST PALM BEACH, FL, 33402-3188, US

(73) Assignee: Continental Automotive France, Toulouse (FR)

(21) Appl. No.: 12/059,882

(22) Filed: Mar. 31, 2008

(30) Foreign Application Priority Data
Jun. 1, 2007 (FR) 0755428

(51) Int. Cl. G06Q 30/00; G06F 15/16; G06F 19/00

(52) U.S. Cl. 705/26; 709/203; 701/300

(57) ABSTRACT

A system for aggregating services for a telecommunication platform is provided. The system includes a data administration server (10) comprising a requests management module (11) and a requests analysis module (12). With the system, targeted data (D4) and requests (R) are received from the requests management module (11) and the whole set of data (D4, R) is transmitted to nonrelevant service data provision servers (S1,S2,S3) for which the requests (R) are not intended, the nonrelevant servers (51, S2, 53) providing additional data in response (D1, D2, D3) which are aggregated by the requests management module (11), the whole set of data (D1, D2, D3, D4) being transmitted thereafter to the telecommunication platform (100) by the requests management module (11). The invention also relates to a method of ordering a good or a service.

### CROSS REFERENCE TO RELATED APPLICATIONS

This application claims priority to French Patent Application Number 0755428 filed Jun. 1, 2007, the entirety of which is incorporated herein by reference.

### FIELD OF THE INVENTION

The invention relates to the field of communications between a server supplying services and a telecommunication system. The invention relates more particularly to a system embedded in a motor vehicle connecting to remote services via a wireless telecommunication link.

### BACKGROUND OF THE INVENTION

Motor vehicles may request information while driving by calling upon services. For example, an individual in his automobile may request the state of the traffic as well as the climatic conditions while driving along. Requesting information via a service requires a wireless communication means so as to allow the vehicle to move while receiving the information. In a conventional manner, communications via satellite, telephone, radio or WiFi make if possible to transmit information to the vehicle.

By virtue of these diverse information media, the driver can call upon various services via the embedded system of the vehicle so as to ascertain the best route, the climatic conditions or to order goods and services so as to ease his journey (book a table in a restaurant, book a hotel room, etc).

Existing communication systems are not very suitable, since they require the driver to enter a large number of parameters into the embedded system to obtain the desired information. Thus, if the driver of the vehicle wishes to book a hotel room in a town situated mid-way along his route, he must make numerous enquiries. He must, first of all, input the names of the departure and arrival towns so as to request his route with a first service. Thereafter he must analyse this route so as to define which town is situated mid-way. Thereafter he must call upon a second service so as to re-enter the name of the town and obtain particulars for the hotels in said town. Finally he must pick up his telephone and book a room, indicating, for example, his bank card information.

Such management of services in a vehicle is unsuitable and even dangerous. The numerous inputs of parameters cause a dip in the driver's concentration and therefore an increase in the risks of an accident. It is then necessary for the driver to have stopped to consult the services, thereby lengthening the duration of his journey.

Requesting information is lengthy, or indeed laborious, thereby deterring a driver from consulting services. Moreover, he is constrained to take out various service subscriptions so as to obtain the desired information, causing the repetition of steps relating to his identification and to payment. Such a system for managing services is slow, impractical and requires deep concentration. It is thus of little interest to a user.

### SUMMARY OF THE INVENTION

The invention of the present application is aimed at alleviating these drawbacks.

For this purpose, it relates to a method of ordering a good or a service of a plurality of goods and services associated with navigation and geo-location data in an operations center, in which

personal navigation and geo-location data to which the good or the service to be ordered corresponds are communicated to the operations center;

all the goods and services offers associated with said personal navigation and geo-location data and forming part of said plurality of goods and services are received from the operations center; and

the good or service offer is selected from said goods and services part transmitted by the operations center before ordering.

Preferably, at least one personal geographical address is communicated to the operations center.

Again preferably, the operations center filters the plurality of goods and services as a function of the personal navigation and geo-location data communicated.

Still preferably, the order is performed gratis for the one making the order, the operations center being paid by the supplier of the good or the service provider.

The goods and services part transmitted by the operations center comprises a description of the good or of the service proposed as well as its geographical location.

Again preferably, the operations center stores a log of the goods and services already ordered.

Again preferably, the operations center filters the plurality of goods and services as a function of the log of the goods and services already ordered.

The invention also relates to a system for aggregating services for a telecommunication platform comprising:

a data administration server linked to service data provision servers, the whole set of servers forming a star comprising a center formed by the administration server and branches formed between the administration server and the service data provision servers;

the administration server comprising a requests management module designed to receive requests arising from the telecommunication platform and transmit them to the relevant service data provision server for which the requests are intended, said relevant service data provision server providing targeted data in response to the requests;

the administration server comprising a requests analysis module, receiving the targeted data and the requests from the requests management module and transmitting the whole set of data to nonrelevant service data provision servers for which the requests are not intended,

the nonrelevant servers providing additional data in response which are aggregated by the requests management module, the whole set of data being transmitted thereafter to the telecommunication platform by the requests management module.

When a driver sends a request to obtain an item of information, additional information is proposed to him, thus perhaps avoiding the need for the latter to make numerous requests. The star arrangement of the network, formed by the servers, advantageously makes it possible to group together the information transmitted by the telecommunication platform, thus avoiding unnecessary duplication of the requests to access each of the services.

Preferably, the administration server comprises a driver customization module designed to filter and enhance the transmission of the requests to the servers and thus to propose preferential services thereto.

Again preferably, the driver customization module comprises a database of preferential parameters, the driver customization module extracting the preferential parameters from the requests so as to store them in the database of preferential parameters.

Preferably, the administration server comprises an identification module making it possible to control access to the various service provision servers.

Again preferably, the identification module comprises a billing module making it possible to control the billing of the various service provision servers, the billing module being hooked up with a participation service provision server designed to bear the cost of access to a service provision server.

Still preferably, the requests management module sends the additional data returned by the service provision server, to the participation service provision server.

Still preferably, the participation service provision server returns participative targeted data which are aggregated by the requests management module.

Still preferably, the participative targeted data are commercial data.

Still preferably, the participative targeted data comprise at least one communication link to an interface for ordering a good or service.

In the most advantageous form of the aggregation system of the invention, the telecommunication platform is a mobile platform.

### BRIEF DESCRIPTION OF THE DRAWINGS

The invention will be better understood with the aid of the following description and the appended drawing in which:

FIG. 1 represents the administration server and the service provision servers forming a star network whose administration server is the center;

FIG. 2 represents a chart of the interaction of the modules of the administration server with the service provision servers of FIG. 1;

FIG. 3 represents another embodiment of the administration server of the invention with a customization module; and

FIG. 4 represents another embodiment of the administration server of the invention with an identification and billing module.

### DETAILED DESCRIPTION

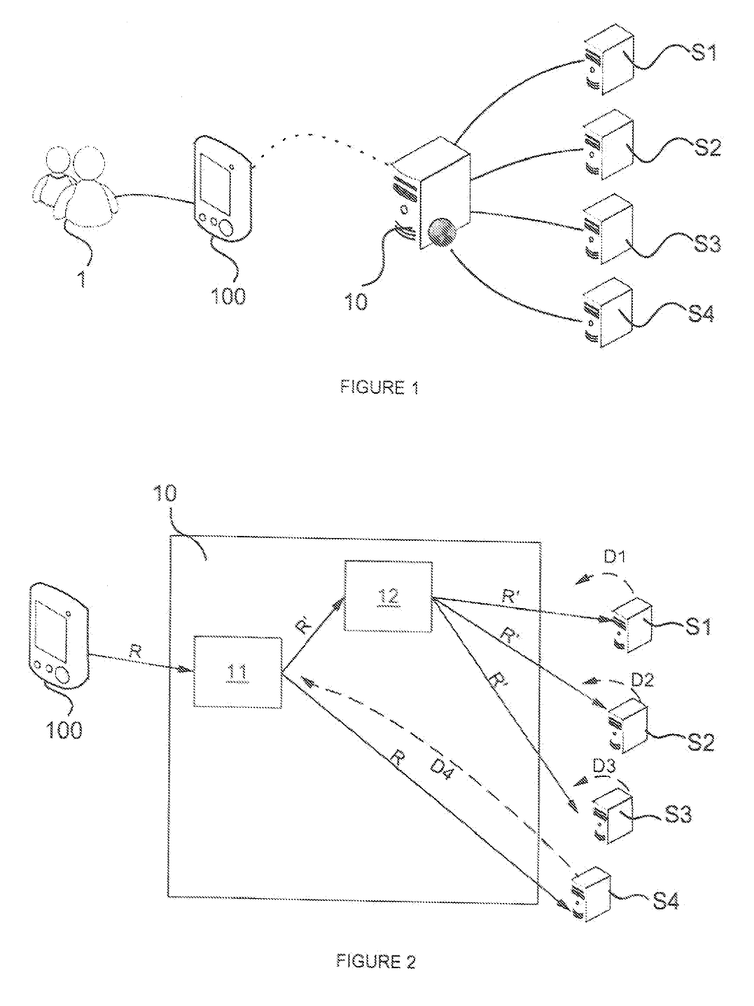

The invention relates to communication between a telecommunication platform 100, which here is a mobile platform, disposed in an automobile, and service provision servers S1-S4, represented in FIG. 1. In this exemplary implementation of the invention, the mobile telecommunication platform 100 takes the form of a mobile cellular telephone 100, a driver of the automobile 1 manipulating his telephone 100 so as to access services.

The mobile telephone 100 can comprise, in addition to a usual facility for hooking up terminals via the telephone network, a communication facility of the WIFI, BLUETOOTH or radio type allowing it to access numerous services.

In this example, the driver 1 accesses the various services via the telephone network to which a subscription has been taken out. It is assumed, for the sake of clarity, that the subscriber and the driver 1 of the automobile are the same people. In order to access the various services, the driver 1 sends requests R via the telephone network to an administration server 10, the administration server 10 processing the requests R.

With reference to FIG. 2, the administration server 10 is linked, in a wire-based or wireless manner, to service provision servers S1-S4, the latter receiving requests R′ arising from the administration server 10, the requests R′ being identical to the requests R or modified on the basis of said requests R. Thus, any request R, sent by the mobile telephone 100, is relayed by the administration server 10 before reaching a service provision server S1-S4.

The administration server 10 is the center of a network formed by the service provision servers S1-S4 and the administration server 10. The network is called a star network as opposed to so-called parallel networks in which a management server is disposed between the telephone 100 and each service provision server S1-S4, the management server separately ensuring the identification of the subscriber to the service which he is accessing.

The administration server 10 comprises a requests management module 11 designed to receive the requests R arising from the mobile telephone 100 and transmit them to the relevant service data provision server, here and for example the server S4. In the following example, the explanation will be limited to the processing of a single request R.

The destination of the request R can be determined when sent by the driver 1, the driver 1 specifying that he wishes, for example, to access a navigation service. When the request R arrives at the management module 11, the request R is directed to the service provision server S4 for which it is intended.

It goes without saying that the destination of the request R can he determined also by a contextual analysis, the driver 1 re-entering solely the name of a town so that the administration server 10 proposes, via a service provision server, a route up to said town.

The service provision server S4 receives the request R and returns targeted data D4 to the requests management module 11.

Once the targeted data D4 have been received by the requests management module 11, the latter transmits said request R and the targeted data D4 to a requests analysis module 12 situated in the administration server 10 and linked to the requests management module 11, together the data D4 and the request R being referenced R′ in FIG. 2.

The requests analysis module 12 receives the data R′ and transmits them to the nonrelevant service data provision servers S1-S3. The service provision servers S1-S3, after receiving the data R′, return additional data D1-D3 to the requests management module 11.

The whole set of data D1-D4 is transmitted thereafter by said requests management module 11 to the mobile telephone 100 so as to be communicated to the driver 1 audibly (voice orders) or visually (display of images on the mobile telephone 100).

The system for aggregating services of the invention will now be explained with the aid of an exemplary implementation.

The driver 1 of the motor vehicle wishes to go from a town A to a town B. The driver sends a route request R to the administration server 10, specifying the names of the towns A and B, by means of his mobile telephone 100 and via the telephone network. The messages management module 11 processes the request R and determines the server for which it is intended.

In this example, the request R is intended for a navigation server S4. The navigation server S4, in response to the request R, returns targeted data D4 comprising a set of images and sound files corresponding, respectively, to the schematized plans of the route between town A and town B and to the directions that the driver 1 must take in the course of the journey (left, right, straight ahead, etc.). The data D4 also comprise various geographical coordinates of the route with the expected times of arrival at said coordinates.

After having received the targeted data D4, the requests management module 11 transmits the request R, with the targeted data D4 (data R′), to the requests analysis module 12. The data R′are transmitted to another service provision server S3, said server S3 being capable of providing the weather conditions at determined geographical coordinates for a determined time slot. The weather service server S3 returns a set of additional data D3 to the requests management module 11. The additional data D3 correspond to the weather conditions for each pair of geographical and temporal data returned by the navigation service S4. Thus, the driver 1 is informed that the weather conditions are mild in the vicinity of town A but worsen mid-way.

The whole set of targeted data D4 and additional data D3 are thereafter sent to the mobile telephone 100 by the requests management module 11. Thus, the driver 1 receives, via his mobile telephone 100, his route between towns A and B and the weather conditions along the journey. This allows the driver 1, in an advantageous manner, to equip his vehicle with tires suited to the weather conditions.

The requests analysis module 12 can also transmit the targeted data D4 to several service provision servers S1-S4. Likewise, the requests analysis module 12 can filter the data transmitted to the service provision servers, for example, by blocking a part of the targeted data D4, such as the schematized plans of the route between town A and town B and the directions that the driver 1 must take in the course of the journey.

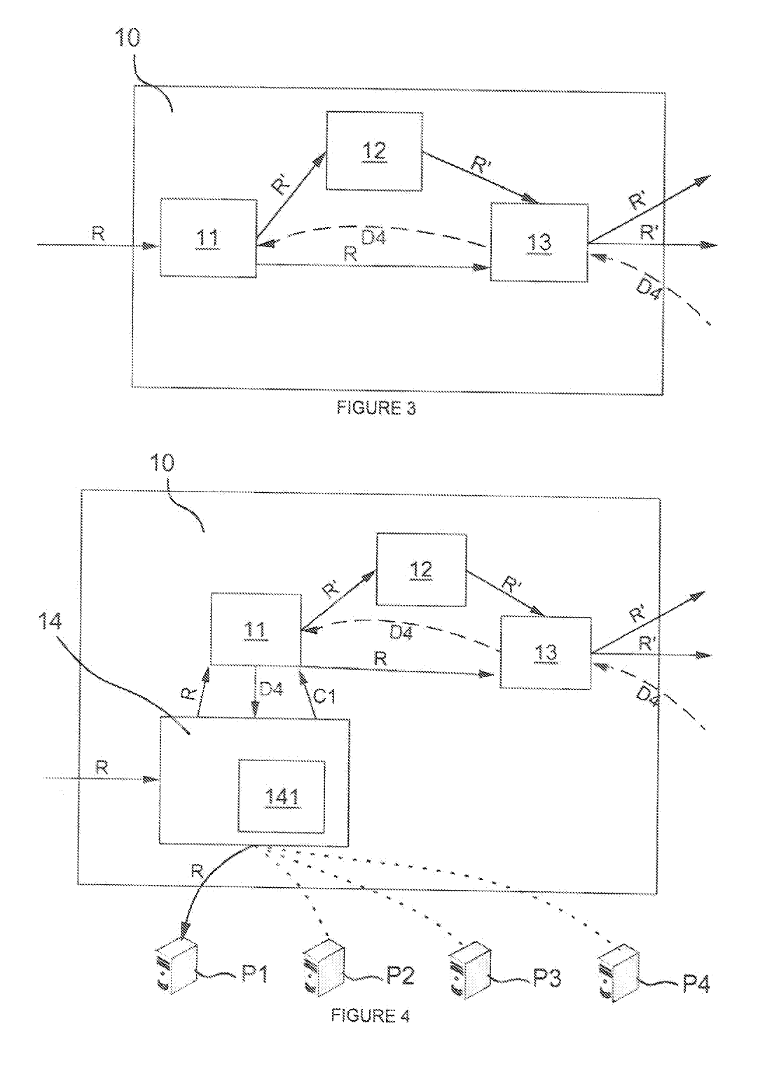

In another embodiment, the system comprises a driver customization module 13 designed to filter the transmission of the requests to the servers S1, S2, S3, S4 as represented in FIG. 3.

The driver customization module 13 is parametrized with preferential parameters making it possible to ensure a filtering and an enhancement of the request R sent by the driver 1. For example, the driver customization module 13 comprises a coast roads preference parameter.

Still with reference to the previous example, when the driver 1 indicates in a request R, the departure town A and arrival town B to the requests management module 11, the driver customization module 13 modifies the request R so as to ask, in an additional manner, for a route between towns A and B passing in proximity to the coast.

In a similar manner, if the driver customization module 13 comprises a parameter stipulating that the driver 1 is interested only in the climatic conditions in proximity to places of high altitude, the targeted data D4 returned by the server S4 are filtered by the customization module 13 so as to send to the weather server S3 only the geographical data whose altitude is greater than the preference parameter of the driver 1 (FIG. 3).

Thus, the customization module 13 makes it possible to provide more precise information to the driver 1 and also makes it possible to prevent the transmission of data to service provision servers S1-S3 which are of no interest to the driver 1. With reference to FIG. 3, the driver customization module 13 does not transmit any data arising from the request R to the service provision server S1.

The requests management module 11, requests analysis module 12 and customization module 13 can be grouped together within one single module.

The preferential parameters can be re-entered manually via the mobile telephone 100 of the driver 1 or extracted during the analysis of the request R. Thus, if a driver 1 requests a route numerous times followed by a state of the climatic conditions by altitude, a preference parameter coupling each route request with a request for the corresponding weather conditions is stored in a customization database. Thus, it suffices for the driver 1 to indicate the name of the towns A and B in order to directly obtain a route with the weather conditions by altitude on his journey.

With reference to FIG. 4, the system of the invention here comprises a single identification module 14 making it possible to verify whether the driver 1 is indeed permitted to access the service provision servers S1-S4 to which the request R can be addressed. Thus, each service provision server S1-S4 does not require its own identification module.

The identification module 14 comprises an identification database comprising the name of the service provision servers S1-S4 to which the driver 1 has subscribed, as well as the identification codes and the passwords of said servers S1-S4. Thus, when the driver 1 requests a service, he carries out only a single step of identification with the administration server 10, the identification module 14 taking responsibility for having the request R be identified, in an individual manner, for each relevant service provision server S1-S4.

Thus, in an exemplary implementation, the driver 1 sends the route request R to the administration server 10, the identification module 14 inviting him to provide his identification information, in the present case, an identifier and a password. After verifying and confirming the identification information, the identification data, stored in the database, are sent to the weather server S3 and navigation server S4 to which the driver 1 has subscribed. The driver 1 can thus, in an advantageous manner, access the services in a fast manner, carrying out a minimum of manipulations with his telephone 100.

The identification module 14 advantageously comprises a billing module 141 so that the driver 1 can access the services in a centralized manner. The identification database comprises, in addition to the identification information, billing data for the driver 1. Thus, for a given service, the database comprises billing data for the driver 1 such as a customer code, a billing address and a delivery address.

The billing module 141 makes it possible to centralize all the transactions between the mobile telephone 100 and the various service provision servers S1-S4.

The identification and billing module 14, situated in the administration server 10, receives the request R from the mobile telephone 100 and analyses it to verify whether the driver 1 is a subscriber and whether he can access the pay service. After verification, the request R is transmitted to the requests management module 11 as represented in FIG. 4.

When a request R, arising from the mobile telephone 100 and intended for a service provision server S4 to which the driver 1 has not subscribed, is received by the identification and billing module 14, said request is hooked up with participation service provision servers P1-P4, termed participation servers P1-P4 and represented in FIG. 4.

Said participation servers P1-P4, which can also be service provision servers S1-S4, intervene with the identification and billing module 14 so as to themselves bear the cost of access to the service S4 to which the driver 1 has not subscribed. Thus, when the driver 1 wants to access the pay navigation service S4, the request R is analysed by the identification and billing module 14. In the identification and billing database, a check is performed to verify whether there exists an identifier of a participation server P1-P4 capable of bearing the cost of the access to the service S4. If such is the case, the identification and billing module 14 sends to the mobile telephone 100 a participation authorization request originating from the participation server P1.

Should the invitation be refused by the driver 1, the latter sends a request R via his mobile telephone 100 to the identification and billing module 14. The participation server P1 remains inactive and the driver 1 must enter billing data so as to access the pay service provision server S4.

Should the driver 1 accept the participation offer, the billing module 14 bills the service of the service provision server S4 to the participation server P1. The request R of the driver 1 is transmitted to the service provision server S4 which returns targeted data D4, the targeted data D4 as well as the original request R being transmitted to the participation server P1.

The participation server P1, such as a nonrelevant service provision server, returns participative additional data C1 to the requests management module 11 so as to enhance the targeted data D4.

Still with reference to the previous example, in which the relevant service provision server S4 is a navigation service S4, the driver 1 sends a request R to access the navigation service S4 and receives an invitation to use a participation server P1 which will bear the cost of access to the navigation service S4. The participation server P1 takes the form here of a commercial advertisements server providing a list C1 of restaurants and hotels along the route of the driver 1.

The list C1 of restaurants and hotels, associated with their geographical coordinates, is sent to the management module 11 so as to be added to the route D4 provided by the navigation service S4, the driver 1 receiving his route for free and benefiting, on the other hand, from targeted commercial propositions.

The list C1 furthermore comprises a communication link to a commercial interface of each of the restaurants and hotels of the list. Thus, the driver 1 can order, by selecting said link, a table in one of the restaurants or a night in one of the hotels of the list.

Selecting the communication link could also bring about the viewing of commercial offers by the driver, such as advertisements and promotional offers relating to the restaurants or hotels of the list C1

Selecting the communication link brings about the billing of the navigation service, provided by the relevant service provision server S4, by the participation server P1.

In another exemplary implementation of the invention, the telecommunication platform, situated in a motor vehicle, takes the form of an onboard computer 100 having a satellite connection. The onboard computer 100 is here linked to a GPS (Global Positioning System) data receiver making it possible to give the position of the vehicle in GPS coordinates (latitude,longitude).

The onboard computer 100 sends a request R to the administration server 10 while integrating the GPS coordinates of the vehicle into the request R. Thus, by indicating solely the name of a town with the aid of the onboard computer 100, the driver 1 can request the route between his current GPS coordinates and the destination town.

The service aggregation system makes it possible to obtain service information by automatically reading out information from the vehicle while requiring only a minimum of manipulations of the onboard computer 100.

The onboard computer 100 can transmit, in addition to the GPS coordinates, the fuel level or the pressure of the tires.

The invention has been presented in respect of a mobile telecommunication platform 100 taking the form of a mobile telephone or an onboard computer. It could involve any other apparatus, conventionally designated by the term “client”, suitable for connecting to service provision servers, such as for example a data personal assistant, a communicating embedded system or a communicating GPS receiver. The invention could also be relevant to a fixed telecommunication platform such as a personal computer, with which a user would send requests from his computer so as to obtain, for example, a route between two places with additional data.

According to the method of ordering a good or a service of the invention, the driver of the vehicle communicates to an operations center, here the administration server, the personal geographical address of the place which he wishes to go to with his vehicle. The administration server comprises a list of offers of goods or services that can be ordered. This list is stored directly on said administration server. It goes without saying that the goods or services list can be stored on a third party server linked to said administration server.

Each good or service of the list comprises a description as well as a geographical address. Thus, for a restaurant of the list, the price of the various dishes available, its opening times and its geographical address are known.

The list of goods or service offers is filtered by the operations center as a function of the personal geographical address transmitted by the driver, the filtered list comprising only offers that are pertinent to the driver.

The driver can choose a good or a service from the filtered list transmitted to him. Returning to the previous example, the geographical addresses of the restaurants allow the driver to rapidly locate the various restaurants of the list on his route, thereby easing his choice from among the restaurants.

Thereafter the driver selects from the list transmitted by the operations center the chosen good or service. He can then book a table, if he has chosen a restaurant, or a night at a hotel with the room category, if he has chosen a hotel. The driver thus saves valuable time on arriving at said restaurant or said hotel.

When the order is placed or the good or service offer viewed, the provider of the service or the supplier of the ordered good pays the operations center for the navigation or location service provided, the driver benefiting gratis from the services of the operations center.

The cost of the navigation is paid by the provider of the service or the supplier of the good. This method of ordering is designated by the person skilled in the art as “Pay Per Navigate To”.

The operations center stores the personal data communicated by the driver as well as a log of the goods and services already ordered so as to define the user's preferences. Thus, during a future communication of a personal address of the driver to the operations center, the list of goods or service offers is filtered by the operations center as a function of the personal geographical address transmitted and his preferences. Thus, if the log of the driver's orders indicates that he has booked only hotel nights, the list transmitted to the driver will comprise mainly hotels, the driver benefiting from customized and targeted offers.

1. Method of ordering a good or a service of a plurality of goods and services associated with navigation and geo-location data in an operations center, the method comprising:
communicating to the operations center personal navigation and geo-location data to which the good or the service to be ordered corresponds;
receiving from the operation center all the goods and services offers associated with said personal navigation and geo-location data and forming part of said plurality of goods and services; and
selecting the good or service offer from said goods and services part transmitted by the operations center before ordering.

2. The method according to claim 1, in which;
at least one personal geographical address is communicated to the operations center.

3. The method according to claim 1, in which:
the operations center filters the plurality of goods and services as a function of the personal navigation and geo-location data communicated.

4. The method according to claim 1, in which;
the order is performed gratis for the one making the order, the operations center being paid by the supplier of the good or the service provider.

5. The method according to claim 1, in which:
said goods and services part transmitted by the operations center comprises a description of the good or of the service proposed as well as its geographical location.

6. The method according to claim 1, in which:
the operations center stores a log of the goods and services already ordered.

7. The method according to claim 6, in which:
the operations center filters the plurality of goods and services as a function of the log of the goods and services already ordered.

8. A system for aggregating services for a telecommunication platform comprising:
a data administration server linked to service data provision servers, the whole set of servers forming a star comprising a center formed by the administration server and branches formed between the administration server and the service data provision servers;
said administration server comprising a requests management module designed to receive requests arising from the telecommunication platform and transmit them to the relevant service data provision server for which the requests are intended, said relevant service data provision server providing targeted data in response to the requests;
said administration server comprising a requests analysis module, receiving the targeted data and the requests from the requests management module and transmitting the whole set of data to nonrelevant service data provision servers for which the requests are not intended;
said nonrelevant servers providing additional data in response which are aggregated by the requests management module, the whole set of data being transmitted thereafter to the telecommunication platform by the requests management module.

9. The system for aggregating services according to claim 8, in which the administration server comprises a driver customization module designed to filter and enhance the transmission of the requests to the servers and thus to propose preferential services thereto.

10. The system for aggregating services according to claim 9, in which the driver customization module comprises a database of preferential parameters.

11. The system for aggregating services according to claim 10, in which the driver customization module extracts the preferential parameters from the requests so as to store them in the database of preferential parameters.

12. The system for aggregating services according to claim 8, in which the administration server comprises an identification module making it possible to control access to the various service provision servers.

13. The system for aggregating services according to claim 12, in which the identification module comprises a billing module making it possible to control the billing of the various service provision servers.

14. The system for aggregating services according to claim 13, in which the billing module is hooked up with a participation service provision server designed to bear the cost of access to a service provision server.

15. The system for aggregating services according to claim 14, in which the requests management module sends the additional data, returned by the service provision server, to the participation service provision server.

16. The system for aggregating services according to claim 15, in which the participation service provision server returns participative targeted data which are aggregated by the requests management module.

17. The system for aggregating services according to claim 16, in which the participative targeted data are commercial data.

18. The system for aggregating services according to claim 17, in which the participative targeted data comprise at least one communication link to an interface for ordering a good or service.

19. The system for aggregating services according to claim 8, in which the telecommunication platform is a mobile platform.
